(19) United States
(12) Patent Application Publication
(10) Pub. No.: US 2023/0219816 A1
(43) Pub. Date: Jul. 13, 2023

(54) METHOD OF THE PRODUCTION OF HYDROGEN

(71) Applicant: SHELL USA, INC., HOUSTON, TX (US)

(72) Inventors: Tathagata GOSWAMI, Amsterdam (NL); Robert SCHOUWENAAR, Amsterdam (NL); Michael TURLEY, Amsterdam (NL); Sven FELSKE, Amsterdam (NL)

(21) Appl. No.: 18/000,949

(22) PCT Filed: Jun. 9, 2021
(86) PCT No.: PCT/EP2021/065433

§ 371 Date: Dec. 7, 2022

(30) Foreign Application Priority Data
Jun. 10, 2020 (EP) 20179362.7

(51) Int. Cl. C01B 3/48; C01B 3/36; B01D 53/047

(52) U.S. Cl. CPC C01B 3/48; C01B 3/36; B01D 53/047; C01B 2203/025; C01B 2203/0283; C01B 2203/0475; C01B 2203/0485; C01B 2203/0405; C01B 2203/0894; C01B 2203/1241; C01B 2203/86; C01B 2203/0445

(57) ABSTRACT

The present invention relates to a method for the production of hydrogen. Hydrogen is used in many different chemical and industrial processes. Hydrogen is also an important fuel for future transportation and other uses as it does not generate any carbon dioxide emissions when used. The invention provides for a process for producing hydrogen comprising the steps of partially oxidizing a hydrocarbon to obtain a synthesis gas, providing the synthesis gas to a reactor in which carbon monoxide is converted to carbon dioxide, removing the carbon dioxide to obtain hydrogen. The carbon dioxide is used in a chemical process and/or stored in a geological reservoir.

### FIELD OF THE INVENTION

The present invention relates to a method for the production of hydrogen.

### BACKGROUND OF THE INVENTION

Hydrogen is used in many different chemical and industrial processes. Hydrogen is also an important fuel for future transportation and other uses as it does not generate any carbon dioxide emissions when used.

There are several ways of producing hydrogen. Hydrogen may be produced by subjecting water to electrolysis or may be produced from hydrocarbons by converting these hydrocarbons into a synthesis gas comprising hydrogen and carbon monoxide (CO) and further converting the carbon monoxide with steam to hydrogen and carbon dioxide followed by one or more purification steps.

Electrolysis of water allows for the carbon dioxide free production of hydrogen, as long as the energy used for the electrolysis is obtained from non-hydrocarbon sources such as wind or solar energy. If the hydrogen is generated without using hydrocarbons it is often referred to as green hydrogen. At present, processes based on electrolysis to obtain hydrogen are very expensive.

The preparation of hydrogen from hydrocarbons is economically more favorable than electrolysis but it has as a disadvantage that carbon dioxide is produced as a byproduct. The production of carbon dioxide takes away the environmental benefit of using hydrogen as for example a fuel in fuel cells.

A process for the preparation of hydrogen from hydrocarbons is steam reforming. Steam reforming is well known in the art. Typically a methane (CH4) comprising feed gas is reacted with steam in the presence of a suitable steam reforming catalyst. The steam reforming reaction is:

CH₄+H₂O→CO+3H₂

Disadvantageously, the (steam) reforming requires energy, especially heat, as it is a strongly endothermic reaction. The required energy, especially heat, for the (steam) reforming may be generated by means of combustion of fuel or natural gas. A disadvantage is that fuel combustion and natural gas combustion result in low pressure exhaust gases with a low concentration of carbon dioxide. The capture of carbon dioxide from such exhaust gases requires a separation process to concentrate the carbon dioxide, and pressurization for sequestration.

A further disadvantage of using reforming is that it the reaction requires a catalyst. Catalysts need to be exchanged when they reach the end of their lifetime or when they get contaminated. This requires the reformer to be brought off-line and interrupting the production of synthesis gas.

Further, the feed to the reformer needs to be treated thoroughly before entering the reformer. This means that extensive gas treatment or feed treatment is required adding to the cost and complexity of a plant using reforming in the production of synthesis gas.

Another downside of using steam reforming is that the synthesis gas, and consequently hydrogen, is produced at relatively low pressures which requires compression for further use.

Hence, a downside of the prior art methods producing H2 and carbon dioxide is that the H2 and carbon dioxide are produced at relatively low pressures and are energy intensive resulting in additional carbon dioxide emissions.

### SUMMARY OF THE INVENTION

The invention provides for a process for producing hydrogen (H₂) comprising the steps of:

Providing to a partial oxidation (POX) reactor an oxidizing gas and a gas comprising hydrocarbons to obtain a synthesis gas comprising hydrogen and carbon monoxide, the partial oxidation reactor is operated at a temperature in the range of 1000 to 1500° C. and at a pressure of at least 40 barg;

Cooling the hot synthesis gas to a temperature below 300° C. to obtain a cooled synthesis gas;

Providing the cooled synthesis gas and water to a second reactor, the reactor being operated at a temperature in the range of 200° C. to 480° C. and comprising a catalyst that converts carbon monoxide in the presence of water into carbon dioxide and hydrogen, to obtain a gas mixture comprising hydrogen and carbon dioxide;

Providing the gas mixture to a carbon dioxide removal unit to obtain a hydrogen rich gas stream and a first carbon dioxide rich gas stream having a pressure of at least 13 barg and a second carbon dioxide rich gas stream having a pressure of at least 0.7 barg;

Providing the first and second carbon dioxide rich gas streams to a compression unit to obtain a third carbon dioxide gas stream having a pressure of at least 40 barg;

Utilizing the carbon dioxide in a chemical process and/or storing the carbon dioxide in a geological reservoir.

### BRIEF DESCRIPTION OF THE DRAWINGS

FIG. 1 shows a line-up according to the present invention.

FIG. 2 shows a line-up according to the present invention.

### DETAILED DESCRIPTION OF THE INVENTION

The invention provides for an improved method for producing hydrogen. The method according to the invention allows for the capture of a large part of the carbon dioxide produced and compress for sequestration. Hence, hydrogen can be produced with little to no carbon dioxide being released to the atmosphere.

A further advantage of the invention is that the method can operated while Sulphur is present in the feed gas to the POX reactor.

A further advantage is that due to high operating temperature compared to prior art methods this invention ensures very high hydrocarbon conversion at high operating pressure. As the method of the present invention can be operated at a much higher pressure than prior art methods. Hydrogen may be obtained at a pressure of up to 60 barg. As hydrogen may be obtained at higher pressures, compared to the prior art, a hydrogen compression step requiring less compression duty is needed or compression of hydrogen is not needed.

This invention produces Carbon dioxide from moderately high to low pressure compare to other close known solutions where only low-pressure Carbon dioxide is produced. Therefore, the Carbon dioxide compression duty in the invention is much lower.

This invention needs significantly less power import compare to other close solutions by producing and internally using energy.

The method according to the present invention comprises the step of providing to a partial oxidation (POX) reactor an oxidizing gas and a gas comprising hydrocarbons to obtain a synthesis gas comprising hydrogen and carbon monoxide, the partial oxidation reactor is operated at a temperature in the range of 1000 to 1500° C. and at a pressure of at least 40 barg.

In a preferred embodiment the oxidizing gas and hydrocarbon containing gas are provided to a single POX reactor. In a POX process the partial oxidation reactor typically comprises a burner placed at the top in a reactor vessel with a refractory lining. Reactants are introduced at the top of the reactor through the burner.

In this POX step, a hydrocarbon comprising gas is reacted with an oxidizing gas at a temperature in the range of 1000 to 1500° C. and preferably in the range of 1150 to 1370° C. and more preferred in the range of 1250 to 1370° C., to obtain a hot raw synthesis gas mixture by means of partial oxidation. The main reaction that takes place is:

CH₄₊½O₂→CO+2H₂

In this POX process all oxidizing gas fed into the burner at the top of the POX reactor reacts in the reactor. Main reaction products are carbon monoxide and hydrogen, but other components, such as steam (H₂O), are also formed. For the present invention, with hydrogen is meant molecular hydrogen unless stated otherwise.

Using POX in the production of hydrogen has several advantages. Firstly, it allows operation at an elevated pressure compared to reforming. This has as an advantage that downstream of the POX reactor higher pressures may be maintained as well which has as a result that a hydrogen rich gas stream may be obtained at pressure which require no further compression or less compression compared to the methods based on reforming.

Secondly, any produced carbon dioxide is part of the high-pressure product stream and not a separate low-pressure flue gas stream. This has as an advantage that carbon dioxide generated during the production of hydrogen requires less compression before it is injected into sub surface reservoirs or used in other processes. As less compression is required, the compression hardware required is less than for processes relying on reforming. The use of POX in case carbon dioxide needs to be stored at elevated pressures, is more energy efficient than using reforming.

Thirdly, POX requires less energy than reforming. Reforming requires steam which needs to be generated and the reaction is endothermic. POX on the other hand is exothermic and requires no energy.

The oxidizing gas used is oxygen or an oxygen-containing gas. Suitable gases include air (containing about 21 volume percent of oxygen) and oxygen enriched air, which may contain at least 60 volume percent oxygen, more suitably at least 95 volume percent and even at least 99.5 volume percent of oxygen. Such substantially pure oxygen is preferably obtained from a water splitter, a cryogenic air separation process or by so-called ion transport membrane processes.

Oxygen may also be obtained with one or more air separation units (ASU). An ASU divides air into its nitrogen and oxygen components.

In case air is used as a source for oxygen, a nitrogen product stream is also obtained. The obtained nitrogen is suitable to be used as a feedstock in the production of fertilizers.

According to the present invention, a water splitter can be used to produce at least a part of the hydrogen rich gas stream and the oxygen rich gas stream. The oxygen rich gas stream is provided to the POX reactor and the hydrogen rich stream may be added to the hydrogen rich stream obtained from the carbon dioxide removal unit. A water splitter is a device that splits water into hydrogen and oxygen. Such a water splitter may be, among others, electrolysis of water using electrical energy, photo electrochemical water splitting, photocatalytic water splitting, thermal decomposition of water and other known in the art methods of water splitting. A preferred water splitter is an electrolyzer. Energy sources for the water splitting will advantageously be provided by renewable power sources, such as solar and/or wind energy.

According to the present disclosure, the oxygen rich gas stream from the water splitter can be advantageously liquified, optionally stored, and re-gasified before use as feed.

Hydrocarbons may be selected from methane, ethane, propane, butane and combinations thereof but could also be biogas. Other hydrocarbon sources are natural gas, off gasses from industrial processes or refinery fuel gas.

Examples of suitable methane comprising feeds include (coal bed) methane, natural gas, biogas associated gas, refinery gas or a mixture of C1-C4 hydrocarbons. The methane comprising feed suitably comprises more than 90 v/v %, especially more than 94%, C1-C4 hydrocarbons and at least 60 v/v % methane, preferably at least 75 v/v %, more preferably at least 90 v/v %. Most preferably natural gas is used.

The hot synthesis gas obtained from the POX reactor is cooled to a temperature of 300° C. or less. The synthesis gas formed in the POX process is cooled, optionally in multiple stages, for effective heat recovery purposes.

In an embodiment the hot synthesis gas resulting from the POX reaction is cooled by indirect heat exchange against water to produce saturated steam and/or super-heated steam and the cooled synthesis gas. With indirect heat exchange against water is meant that water is used as a coolant, but the hot synthesis gas is not contacted directly with the coolant. The coolant is contacted with tubes through which the hot synthesis gas is flowing. Heat is exchanged via the tube walls to the coolant. In cooling the synthesis gas steam is produced. In an embodiment the generated steam is provided to a second reactor located downstream of the cooler to satisfy the steam demand of the shift reaction. In an embodiment part of the generated steam is superheated and used for power generation in a steam turbine.

The cooling of the hot synthesis gas resulting from the POX reaction to obtain the synthesis gas by indirect heat exchange against water to produce saturated steam and/or superheated steam is preferably done in a heat exchanger having a pressure of between 5 and 15 MPa. The hot synthesis gas is cooled by indirect heat exchange of water against the hot synthesis gas to temperatures below 450° C. In an embodiment the heat exchanger is vertically oriented vessel comprising one or more conduits being spirally formed around a vertical axis of the vessel. The vessel is provided with an inlet for hot synthesis gas fluidly connected to the lower end of the conduit for upwardly passage of hot gas through the spirally formed conduit, an outlet for cooled synthesis gas fluidly connected to the upper end of the conduit, a second inlet for fresh water and a vessel outlet for steam. The vessel is further provided with a water bath space in the lower end of the vessel and a saturated steam collection space above said water bath space. The spirally formed conduit comprises a spirally formed evaporating section located in the water bath space and additionally may have a spirally formed super heater section at the upper end of the vessel, wherein each of the one or more conduits of the super heater section is individually surrounded by a second conduit forming an annular space between said super heater conduit and said second conduit. The annular space is provided with an inlet for saturated steam fluidly connected to the saturated steam collection space and an outlet for steam located at the opposite end of said annular space and fluidly connected to the vessel outlet for steam and wherein outlet or inlet for steam are positioned in water bath space.

In the heat exchanger saturated steam may flow co-currently with the hot gas or counter currently with the hot gas through the annular space. In a co-current embodiment, the inlet is placed in the space slightly above the water bath space in the lower section of the steam space. In a counter-current embodiment of the cooler the inlet is placed at the top of the saturated steam space. In case of the co-current embodiment a separate supply conduit will preferably be present to supply saturated steam to the inlet from the saturated steam collection space.

In an embodiment the synthesis gas obtained in the previously discussed cooling step by indirect cooling, is cooled further by indirect heat exchange against a HC containing gas or boiler feed water to obtain a cooled synthesis gas at temperatures of 200° C. or less and a preheated hydrocarbon comprising gas or boiler feed water. The preheated hydrocarbon comprising gas is provided to the POX reactor. Hence the cooled synthesis gas obtained in a cooling step according to this embodiment has a temperature of 200° C. or less.

In an embodiment the hot synthesis gas resulting from the POX reaction is cooled by quenching in a water bath to produce a cooled and water rich synthesis gas below 300° C. With quenching the synthesis gas with water is meant that the synthesis gas is sent into a water bath where it is in direct contact with water and cooled by evaporating part of the water. In a preferred embodiment the water path is located in the lower part of the reactor vessel, whereby a refractory lined reaction section is connected with the water bath section via a cooled dip tube. The dip tube releases the synthesis gas into the water bath below the water level. Due to the direct contact of water and hot synthesis gas, a large amount of water is evaporated. Thereby, a cooled synthesis gas is produced. The cooled synthesis obtained in this embodiment is rich in water.

In an embodiment the cooled synthesis gas is provided to a soot scrubber. In the soot scrubber the soot containing synthesis gas is flowing counter currently against wash water through a packing where the cold water is condensing majority of the steam in the synthesis gas and washes the soot particles out of the gas. Most wash water is cooled and recycled back to the top of the soot scrubber. Thereby, in the soot scrubber the soot generated in the POX reactor and present in the synthesis gas is removed.

The present invention further provides a step in which the cooled synthesis gas and optionally scrubbed synthesis gas, and water are provided to a second reactor. The water is preferably provided in the form of steam. In the second reactor water and synthesis gas are contacted with a catalyst. The catalyst converts carbon monoxide in the presence of water into carbon dioxide and hydrogen, to obtain a gas mixture comprising hydrogen and carbon dioxide. The conversion of carbon monoxide into hydrogen and carbon dioxide is referred to as the water gas shift reaction. The second reactor may also be referred to as the water gas shift reactor. The reaction that takes place is:

CO+H₂O→CO₂+H₂

The conversion of carbon monoxide to carbon dioxide is at least 90%. This means that at least 90% of the carbon monoxide provided to the reactor is converted into carbon dioxide. Preferably, the carbon monoxide to carbon dioxide conversion is at least 95%.

In an embodiment of the invention the catalysts for the water gas shift reaction is selected from the group consisting of a conventional CoMo sour gas shift catalyst, a CoMo low steam sour gas shift catalyst, a CuZn high temperature shift catalyst, a CuZn medium temperature shift catalyst, a CuZn isothermal shift catalyst, a CuZn low temperature shift, or a ZnAl low steam high temperature shift catalyst, or a combination thereof.

In an embodiment part of the steam obtained from the synthesis gas cooling step is provided to the second reactor. By using the steam generated by cooling of the synthesis gas, no additional energy is required for the generation of the steam that is needed for the shift reaction.

In a further embodiment the cooled and optionally scrubbed synthesis gas is mixed with water in a saturator column prior to being mixed with steam and thereafter provided to the reactor. In case the cooled synthesis gas is provided to a saturator first, the method of the invention comprises saturating the synthesis gas with water in a saturator column having a cavity, a first inlet, a second inlet wherein the first inlet is positioned lower in the saturator column than the second inlet, and at least one outlet at the top of the column and a second outlet at the bottom of the column, fluidly connected to a cavity in the saturator/vessel, comprising the steps of:
Providing the synthesis gas to the cavity of the saturator column via the first inlet;
Providing the water to the cavity in the column via the second inlet;
Allowing the water and synthesis gas to contact in the cavity counter currently;
The water heats the synthesis gas whilst part of the water evaporates into the vapor phase until the synthesis gas is saturated;
Withdrawing via the outlet at the top from the column, a saturated synthesis gas;
Withdrawing from the outlet at the bottom the remaining water.

Optionally, the gas mixture obtained from the water gas shift reaction is provided to a desaturator to remove any water. These are well known in the art.

In an embodiment of the invention the second reactor is a water gas shift reactor and the gas stream obtained from the second reactor is provided to a further water gas shift reactor. The further water gas shift reactor can be operated at similar or lower inlet temperature than the second reactor and can have the same or a different catalyst. By applying two water gas shift reactors in series more carbon monoxide is converted into carbon dioxide.

In the method according to the invention the gas mixture comprising hydrogen and carbon dioxide is provided to a carbon dioxide removal unit to obtain a first hydrogen rich gas stream and a first carbon dioxide rich gas stream having a pressure of at least 13 barg and a second carbon dioxide rich gas stream having a pressure of at least 0.7 barg.

Preferably the carbon dioxide removal unit comprises a column with a solvent. In an embodiment the gas mixture obtained from the water gas shift reactor is provided to the column and contacted in the column with the solvent. The carbon dioxide removal unit preferably comprises an aqueous absorbent solution comprising an absorbent selected from the group consisting of Diisopropanolamine, Methyl diethanolamine (MDEA), Piperazine, Sulfolane or a combination thereof and preferably MDEA, Piperazine or Sulfolane. MDEA is preferably present in an amount in the range of 20 wt % to 60 wt %, Piperazine in the range of 2 wt % to 7 wt % and Sulfolane in the range of 0 wt % to 35 wt % (wt % is relative to the total weight of the aqueous solution).

In an embodiment of the invention the step-in which carbon dioxide is removed from the hydrogen and carbon dioxide containing gas stream, comprises the following steps:

a) an absorption step wherein the hydrogen and carbon dioxide containing gas is contacted in countercurrent with an aqueous absorbent solution and forming a product stream rich in hydrogen and having reduced carbon dioxide content and a liquid absorbent solution enriched with carbon dioxide;

b) flashing the liquid absorbent solution enriched with carbon dioxide to a pressure of at least 13 barg releasing at least 50% of the carbon dioxide in the absorbent solution, obtaining a first gas stream comprising carbon dioxide and a second absorbent solution comprising carbon dioxide;

c) Providing the second absorbent solution comprising carbon dioxide to a regeneration column;

d) Regenerating the absorbent solution wherein the second absorbent solution comprising carbon dioxide obtained from step b) is treated to release at least part of the carbon dioxide, thereby forming a regenerated liquid absorbent solution lean in carbon dioxide and a second gas stream containing carbon dioxide and having a pressure of at least 0.7 barg, and

e) recycling at least part of the lean absorbent solution from step d) as at least part of the aqueous absorbent solution to step a).

The method further comprises the step of a first and a second carbon dioxide rich gas stream to a compression unit to obtain a third carbon dioxide gas stream having a pressure of at least 43 barg. The compression unit raises the pressure of the gas streams to a level which allows for further use of the carbon dioxide in other chemical processes or for injection in a geological reservoir. It is an advantage of the present invention that part of the carbon dioxide is obtained at a pressure of at least 13 barg. As this is at elevated pressure levels compared to prior art methods for obtaining hydrogen from hydrocarbons, smaller compression units are required for the carbon dioxide making this method economically more advantageous. Also, as the compressor unit is smaller it is less complex making maintenance easier.

In an embodiment of the invention the carbon dioxide compression unit comprises at least 3 compressors stages, a first, second and third compressor stage, fluidly connected in series. The provision of the first and second carbon dioxide rich gas streams to and the operation of such a compression unit comprises the following steps:
Providing the second carbon dioxide rich gas stream to a first compressor stage, obtaining a first compressed gas stream having a pressure of at least 4.0 barg and preferably lies in the range of 5-9 barg;
Providing the first compressed gas stream to a second compressor stage, obtaining a second compressed gas stream having a pressure of at least 13 barg and preferably lies in the range of 15 to 21 barg;
Providing the second compressed gas stream and the first carbon dioxide rich gas stream to a third compressor stage to obtain a third compressed gas stream having a pressure of at least 43 barg.

As the first carbon dioxide rich stream is already at an elevated pressure compared to the prior art, smaller compression units are required for the first and second compressor stages. This reduces the costs for the compression unit and reduces the size of these compressor stages.

Optionally, the method according to the invention comprises a step in which the remaining hydrogen in the third compressed gas stream is converted with oxygen to water in a further reactor. This reactor comprises a catalyst that catalyzes the conversion of oxygen and hydrogen into water. The catalyst is for example a Platinum or Palladium based catalyst. The oxygen content is adjusted such, that the remaining hydrogen content is less than 50 ppmv, preferably less than 10 ppmv. This step is also referred to as

CO₂ conditioning and the reactor is referred to as the CO₂ conditioning reactor.

Optionally the third compressed gas stream is dried, optionally after CO₂ conditioning. In case water is present it may be beneficial to remove this from the gas stream prior to further use. Preferably the drying of this gas stream is done with glycol drying or by using a mol sieve.

Optionally, the third carbon dioxide rich gas stream is liquified after drying for export. This is done in an auto-refrigeration process by compressing and letting down the pressure of the CO₂ stream. In an embodiment of the present invention at least 80%, preferably at least 90% and more preferred at least 99% of the carbon atoms originating from the hydrocarbons provided to the partial oxidation reactor are present as carbon dioxide in the first and second carbon dioxide rich streams obtained from the carbon dioxide removal unit.

The third carbon dioxide rich stream, optionally dried, may be utilized in further chemical processes or can be stored in a geological reservoir. By injecting the carbon dioxide into geological reservoirs, the carbon dioxide emission for the present invention is very little to none. This has as a benefit that hydrogen is produced without emitting any carbon dioxide into the atmosphere. Hydrogen obtained by utilizing hydrocarbons but without emitting carbon dioxide into the atmosphere is referred to as blue hydrogen.

The carbon dioxide may be used in a process for the production of ureum. In such a process carbon dioxide is reacted with ammonia. Ammonia may also be obtained by reacting nitrogen obtained by the ASU with hydrogen from the hydrogen rich stream. Ammonia obtained in this way is known as blue ammonia.

In an embodiment of the present invention the first carbon dioxide rich gas stream contains at least 50% of the carbon dioxide relative to the amount of carbon dioxide provided to the carbon dioxide removal unit. Preferably at least 60% and more preferred at least 70% of the carbon dioxide relative to the amount of carbon dioxide provided to the carbon dioxide removal unit. The advantage of having these large amounts of carbon dioxide present in the first carbon dioxide rich stream is that a large part of the carbon dioxide is already at a higher pressure. Which means that a smaller amount (and volume) of carbon dioxide needs to be compressed from the lower pressure of the second carbon dioxide rich stream to at least 43 barg. Advantageously, this reduces the volume required for the first compressor stage in the compressor unit.

In an embodiment of the present invention the first hydrogen rich gas is provided to a third reactor comprising a methanation catalyst. The methanation catalyst converts the residual carbon monoxide and carbon dioxide into methane at temperatures between 250° C. to 380° C., to obtain a second hydrogen rich gas. The third reactor may also be referred to as the methanation reactor. The two reactions that take place are:

CO+3H₂→CH₄+H₂O

CO₂+4H₂→CH₄+2H₂O

This embodiment is preferred in case the hydrogen will be supplied to a natural gas grid. Adding hydrogen to a natural gas grid allows for the reduction of carbon dioxide emissions in case the natural gas is used in heating (of houses for example), cooking, heating of water or the generation of electricity. As part of the heat is now generated by burning hydrogen in place of natural gas less carbon dioxide will be generated resulting in the lowering of domestic carbon dioxide emissions and gas-powered power plants. Preferably the reaction takes place at a temperature in the range of 250 to 380° C.

Hence, in an embodiment of the present invention the first hydrogen rich gas, second hydrogen rich gas or a combination of one or more, is injected into a gas grid for distributing natural gas, preferably the first hydrogen rich gas, second hydrogen rich gas or a combination of one or more is caused to mix with natural gas in the gas grid or prior to injection into the gas grid. Optionally the first and/or second hydrogen rich gas streams are mixed with natural gas before being provided to the gas grid in order to obtain a good mixture of hydrogen and natural gas. Preferably the second hydrogen rich gas stream is provided to a gas grid. As natural gas comprises mostly methane, the small amounts of methane present in the second hydrogen rich gas will not have a detrimental effect.

In an embodiment of the present invention Sulphur compounds are removed from the gas comprising hydrocarbons, or the (shifted) synthesis gas and and/or the first hydrogen rich gas. In this embodiment the method comprises a step of providing hydrocarbons, the (shifted) synthesis gas and/or the first hydrogen rich gas to a Sulphur removal unit in which Sulphur is removed. Preferably, in the Sulphur unit the hydrocarbons, the (shifted) synthesis gas and/or the first hydrogen rich gas is contacted with a zinc oxide or copper zinc oxide bed. The Sulphur compounds chemically adsorb to the bed while other components flow through the bed.

In an embodiment of the present invention the method comprises the step of subjecting the first hydrogen rich stream to pressure swing absorption (PSA) to obtain a pure hydrogen gas stream consisting for at least 98 vol % of hydrogen and an effluent gas stream, preferably the pure hydrogen gas stream consists for at least 99.9 vol % of hydrogen and an effluent gas stream. Hydrogen having a purity of at least 99.9 vol % or more may be used as fuel for fuel cells. Fuel cells are for example used in cars. PSA methods and installation that may be used in the present invention are those marketed for example by Honeywell UOP and Linde. In an embodiment the PSA step is preceded by a separation step based on a membrane. Preferably a hollow fiber membrane is used. The combination of a membrane separation step and a PSA step allows for a hydrogen gas of high purity.

Optionally, the PSA effluent gas stream from the PSA is compressed and sent to a second PSA to recover additional hydrogen. The hydrogen rich stream from the second PSA has a purity of at least 98 vol %, preferably above 99 vol % of hydrogen and a second effluent gas stream. Overall recovery rate of hydrogen is at least 95 vol %, preferably above 98 vol %. The hydrogen enriched stream obtained from the second PSA may be combined with the hydrogen enriched stream obtained in the first PSA. As a PSA, a PSA system for hydrogen purification as offered by Linde plc. or Honeywell UOP may be used.

In an embodiment of the present indentation the first hydrogen rich gas is split. Part of the gas is provided to a reactor comprising a methanation catalyst, while the other part is provided to a pressure swing absorption (PSA).

Optionally, both product streams and a fraction of these individual hydrogen rich product streams are mixed again to achieve a target purity of the hydrogen product. Preferably, 10-70 vol % of the first hydrogen rich gas is provided to a PSA and the remainder of the first hydrogen rich gas is provided to the reactor comprising a methanation catalyst.

In another embodiment of the present invention the first hydrogen rich stream is provided to a gas separation unit comprising a membrane. This unit separates hydrogen from other compounds, obtaining a pure hydrogen gas stream consisting for at least 95 vol % of hydrogen, preferably for at least 98 vol %, and a retentate gas stream. A unit that may be used is the PolySep Membrane System as marketed by Honeywell UOP. In an embodiment, the membrane is a carbon molecular sieve membrane and more preferred a hollow fibre membrane. For example, those obtainable with a method according to WO2015048754.

The hydrogen rich stream obtained with the PSA unit or membrane separation unit may be provided to containers for storage and/or transport. In an embodiment the hydrogen from a PSA unit or membrane unit is liquified first before storage and/or transport.

The invention further provides for a system for producing hydrogen comprising a single partial oxidation reactor, a cooling unit for cooling hot synthesis gas, a water gas shift reactor, a carbon dioxide removal unit having two outlets for carbon dioxide rich gas streams and an outlet for a hydrogen rich stream. The two outlets for carbon dioxide rich gas streams are connected to a compression unit. The compression unit is connected for example to an installation for injecting carbon dioxide into a geological reservoir. With single is meant that the hydrocarbon containing gas is converted into hot synthesis gas in one POX reactor after which the synthesis gas is cooled.

In an embodiment of the invention the system further comprises a methanation reactor which has an inlet which is connected to the outlet of hydrogen rich gas of the carbon dioxide removal unit. The outlet of the methanation reactor is preferably in fluid connection with a gas grid for transporting natural gas.

In another embodiment of the present invention the hydrogen rich gas from the third reactor is sent to a modified PSA without CO removal capacity for further purification. The hydrogen enriched stream obtained from the PSA may be used for further processing or provided to a gas grid.

The method according to the present invention may be executed in a system according to the present invention.

The invention further provides for the use of a system according to the present invention in lowering the hydrocarbon content in a natural gas stream in a gas grid by adding hydrogen to the natural gas.

### DETAILED DESCRIPTION OF THE DRAWINGS

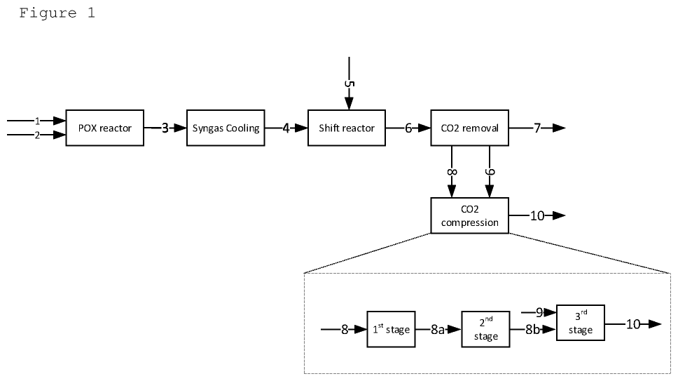

FIG. 1 shows a process line-up according to the present invention. The gas compromising hydrocarbons (1) and the oxidizing gas (2) are fed to a partial oxidation (POX) reactor where at temperatures between 1000 to 1500° C. and a pressure of 40 barg or higher a hot synthesis gas (3) is produced. The hot synthesis gas (3) is then cooled to temperatures below 200° C. to obtain a cooled synthesis gas (4). The cooled synthesis gas (4) is fed together with steam (5) to a shift reactor where most of the carbon monoxide in the synthesis gas is converted with the provided steam and to produce a gas mixture comprising hydrogen and carbon dioxide (6). This gas mixture is then treated in a carbon dioxide removal unit to obtain a first hydrogen rich product stream (7). In addition, a first carbon dioxide stream (9) at a pressure of at least 13 barg and a second carbon dioxide rich stream (8) of at least 0.7 barg are obtained. The second carbon dioxide rich stream is sent to a first compression stage to receive first compressed gas stream (8b) of at least 4 barg. Thereafter, it is sent to a second compression stage to obtain a second compressed gas stream (8b) of at least 13 barg. The second compressed gas steam (8b) and the first carbon dioxide rich gas stream (9) are then combined and send to a third compression stage to obtain a third carbon dioxide rich gas stream (10) of at least 43 barg.

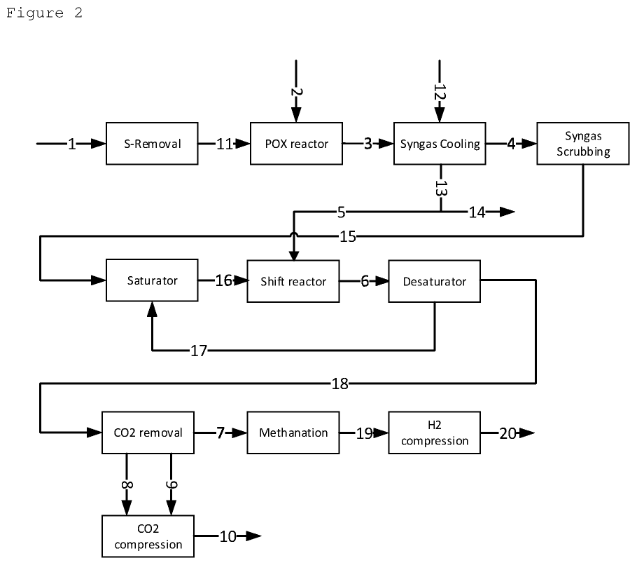

FIG. 2 shows the general process line-up of the process. This line-up is suitable for producing hydrogen from hydrocarbons and providing the hydrogen to a natural gas grid. The gas compromising hydrocarbons (1) is optionally de-sulphurized in ZnO guard bed to obtain a de-sulphurized gas compromising hydrocarbons (11). The de-sulphurized gas compromising hydrocarbons (11) and the oxidizing gas (2) are fed to a partial oxidation reactor where at temperatures between 1000 to 1500° C. and a pressure of 40 barg or higher a hot synthesis gas (3) is produced. The hot synthesis gas (3) is then cooled with water (12) to temperatures below 300° C. to obtain a cooled synthesis gas (4) and a saturated or superheated steam stream (13). Part of the produced steam (13) will be used as feed for the shift section (5), while excess steam (14) is exported to other consumers outside this process. The cooled synthesis gas (4) washed in a scrubber in counter current flow with water to remove any soot particles formed in the POX reactor to obtain a cleaned cooled synthesis gas (15). The cleaned cooled synthesis gas (15) is send to a saturator column where the synthesis gas is flowing counter-currently with hot water through a column and a saturated warm synthesis gas (16) is obtained. The warm saturated synthesis gas (16) is fed together with the required amount of steam (5) to a shift reactor where most of the carbon monoxide in the synthesis gas is converted with the provided steam and to produce a gas mixture comprising hydrogen and carbon dioxide (6). In a desaturator column the gas mixture compromising hydrogen and carbon dioxide is washed counter-currently with cold water to remove majority of the water to obtain a cooled desaturated gas mixture (18) and a water flow which is recycled back to the saturator column (17). The cooled desaturated gas mixture is then treated in a carbon dioxide removal unit to obtain a first hydrogen rich product stream (7). In addition, a first carbon dioxide stream (9) at a pressure of at least 13 barg and a second carbon dioxide rich stream (8) of at least 0.7 barg are obtained. The second carbon dioxide rich stream is sent to a first compression stage to receive first compressed gas stream (8b) of at least 4 barg. Thereafter, it is sent to a second compression stage to obtain a second compressed gas stream (8b) of at least 13 barg. The second compressed gas steam (8b) and the first carbon dioxide rich gas stream (9) are then combined and send to a third compression stage to obtain a third carbon dioxide rich gas stream (10) of at least 43 barg. The first hydrogen rich gas stream (7) is sent to a methanation reactor where remaining carbon monoxide and carbon dioxide is converted to methane and a second hydrogen rich gas stream (19) is obtained. The second hydrogen rich gas stream is in a final step send to a compressor to obtain a third hydrogen rich gas stream (20) at the required pressure for sending it to a natural gas distribution grid.

The appended claims, by way of this reference, form part of this specification and may be combined with one or more of the embodiments of the invention as described in this specification.

The invention will be explained further by means of the following non-limiting examples.

### EXAMPLE 1

The following example refers to the processes as explained in the different embodiments of the present invention as shown in FIG. 1. Table 1 illustrates the differences in compression duty between a potential line-up using an ATR (auto thermal reformer) for synthesis gas manufacturing resulting in a hydrogen pressure of 30 bar upstream of the hydrogen compressor and a similar line-up using partial oxidation for synthesis gas manufacturing resulting in a pressure of 47 bar. The feed hydrogen flow and temperature to the compressor is identical. Same is the case for the compressed Hydrogen. For this example, the 1st stage hydrogen compression step of the ATR line-up is selected such that the outlet is similar the product stream provided by the partial oxidation line-up. The 2nd stage compression for ATR and first stage compression stage for partial oxidation are therefore identical. Hence when using ATR an additional compression stage is required.

For the line up comprising POX, the selected outlet pressure of 72.3 bar. Consequently, the first stage needed for the ATR line-up is not required. Therefore, for the line-up using POX, the duty for the first stage compression and cooling is not required, resulting in a saving of more than 50% in power. This is significant when generating hydrogen while keeping the carbon dioxide emissions as low as possible.

TABLE 1

| | | | Inlet | outlet | | | | air |
|---|---|---|---|---|---|---|---|---|
| | | flow | pressure | pressure | inlet T | outlet T | compressor | cooler |
| | | kg/h | bar | bar | ° C. | ° C. | kW | kW |
| ATR | 1st | 3.09E+04 | 30 | 47 | 60 | 118 | 5140 | 5102 |
| | stage | | | | | | | |
| | 2nd | | 47 | 72.3 | 60 | 116 | 5014 | 5127 |
| | stage | | | | | | | |
| POX | 1st | 3.09E+04 | 47 | 72.3 | 60 | 116 | 5014 | 5127 |
| | stage | | | | | | | |

### EXAMPLE 2

The following example refers to the processes as explained in the different embodiments of the present invention as described in FIG. 1.

Table 2 illustrates the differences in compression duty for the carbon dioxide between a blue hydrogen line-up using a conventional amine process and a single carbon dioxide product stream at 0.7 barg and the proposed amine process where a first carbon dioxide stream of 13 barg and a second carbon dioxide product stream at 0.7 barg are obtained, whereby the removed carbon dioxide is split evenly between the first and second carbon dioxide rich stream.

The discharge pressure after first stage is 4 barg, after the second stage 13 barg, and after the third stage 43 barg.

For the selected outlet pressure of 43 barg, the duty for the first and second stage compression and cooling is significantly reduced. Compared to the conventional amine process, only around 65% of the compression duty is required.

TABLE 2

| | first stage | | | second stage | | | third stage | | |
|---|---|---|---|---|---|---|---|---|---|
| | flow | comp. | cooler | flow | Comp. | cooler | flow | comp. | cooler |
| | rate | duty | duty | rate | duty | duty | rate | duty | duty |
| | kg/h | kW | kW | kg/h | kW | kW | kg/h | kW | kW |
| single | 1.92E+05 | 4936 | 6705 | 1.92E+05 | 4425 | 5125 | 1.92E+05 | 4559 | 6713 |
| inlet | | | | | | | | | |
| stream | | | | | | | | | |
| two | 9.62E+04 | 2468 | 3353 | 9.62E+04 | 2212 | 8339⁽¹⁾ | 1.92E+05 | 4364 | 6370 |
| inlet | | | | | | | | | |
| streams | | | | | | | | | |

⁽¹⁾Duty for combined flow

We claim:

1. A method for producing hydrogen comprising the steps of:
Providing to a single partial oxidation (POX) reactor an oxidizing gas and a gas comprising hydrocarbons to obtain a synthesis gas comprising hydrogen and carbon monoxide, the partial oxidation reactor is operated at a temperature in the range of 1000 to 1500° C. and at a pressure of at least 40 barg;
Cooling the hot synthesis gas to a temperature below 300° C. to obtain a cooled synthesis gas;
Providing the cooled synthesis gas and water to a second reactor, the reactor being operated at a temperature in the range of 200° C. to 480° C. and comprising a catalyst that converts carbon monoxide in the presence of water into carbon dioxide and hydrogen, to obtain a gas mixture comprising hydrogen and carbon dioxide;
Providing the gas mixture to a carbon dioxide removal unit to obtain a hydrogen rich gas stream and a first carbon dioxide rich gas stream having a pressure of at least 13 barg and a second carbon dioxide rich gas stream having a pressure of at least 0.7 barg;
Providing the first and second carbon dioxide rich gas streams to a compression unit to obtain a third carbon dioxide gas stream having a pressure of at least 40 barg;
Utilizing the carbon dioxide in a chemical process and/or storing the carbon dioxide in a geological reservoir.

2. The method according to claim 1 wherein the first carbon dioxide rich gas stream contains at least 50% of the carbon dioxide relative to the amount of carbon dioxide provided to the carbon dioxide removal unit.

3. The method according to claim 1 wherein the hydrogen rich gas is provided to a third reactor comprising a nickel based methanation catalyst, in which residual carbon monoxide and carbon dioxide is converted into methane, to obtain a second hydrogen rich gas.

4. The method according to claim 1 wherein the compression unit comprises at least 3 compressors fluidly connected in series and the step of providing the first and second carbon dioxide rich gas streams to a compression unit comprises the following steps:
Providing the second carbon dioxide rich gas stream to a first compressor, obtaining a first compressed gas stream having a pressure of at least 4.0 barg;
Providing the first compressed gas stream to a second compressor, obtaining a second compressed gas stream having a pressure in the range at least 13 barg;
Providing the second compressed gas stream and the first carbon dioxide rich gas stream to a third compressor to obtain a third compressed gas stream having a pressure of at least 43 barg;
Optionally drying the third compressed gas stream.

5. The method according claim 1 wherein the gas comprising hydrocarbons, the synthesis gas and/or the first hydrogen rich gas is provided to a Sulphur removal unit in which Sulphur is removed.

6. The method according claim 1 wherein the first hydrogen rich gas, second hydrogen rich gas or a combination of one or more, is injected into a gas grid for distributing natural gas, preferably the first hydrogen rich gas, second hydrogen rich gas or a combination of one or more is caused to mix with natural gas in the gas grid or prior to injection into the gas grid.

7. The method according to claim 1 wherein the hydrogen rich gas is provided to a compressor to obtain a further hydrogen stream having a pressure of at least 40 barg.

8. The method according to claim 1 wherein the carbon dioxide removal unit comprises a solvent preferably selected from the group consisting of Diisopropanolamine, Methyl-diethanolamine (MDEA), Piperazine, Sulfolane or a combination thereof.

9. The method according to claim 1 further comprising the step of subjecting the first hydrogen rich stream to pressure swing absorption obtaining a pure hydrogen gas stream consisting for at least 98 vol % of hydrogen and an effluent gas stream, preferably the pure hydrogen gas stream consists for at least 99 vol % of hydrogen.

10. The method according to claim 1 wherein the hydrogen rich stream is provided to a gas separation unit comprising a membrane, obtaining a pure hydrogen gas stream consisting for at least 95 vol % of hydrogen, preferably for at least 98 vol %, and a retentate gas stream, preferably the membrane is a carbon molecular sieve membrane and more preferably a hollow fibre membrane.

11. The method according to claim 9 wherein the pure hydrogen stream is provided to containers for storage and/or transport.

12. The method according to claim 1 wherein at least 80%, preferably at least 90%, of the carbon atoms originating from the hydrocarbons provided to the partial oxidation reactor are present as carbon dioxide in the first and second carbon dioxide rich streams obtained from the carbon dioxide removal unit.

13. The method according to claim 1 wherein the step of cooling the hot synthesis gas comprises the steps of:
Cooling of the hot synthesis gas resulting from the POX reaction by indirect heat exchange against water to produce saturated steam and/or super-heated steam and the cooled synthesis gas;
Optionally feeding at least a part of the saturated steam and/or super-heated steam together with the cooled synthesis gas to the second reactor.

14. The method according to claim 1 wherein the hydrocarbon containing gas stream is a natural gas stream, a hydrocarbon containing off gas, refinery fuel gas, biogas or a combination thereof.

15. The method according to claim 1, comprising a step of saturating the synthesis gas with water in a saturator column having a cavity, a first inlet, a second inlet wherein the first inlet is positioned lower in the saturator column than the second inlet, and at least one outlet at the top of the column and a second outlet at the bottom of the column, fluidly connected to a cavity in the saturator/vessel, comprising the steps of:
Providing the synthesis gas to the cavity of the saturator column via the first inlet;
Providing the water to the cavity in the column via the second inlet;
Allowing the water and synthesis gas to contact in the cavity counter currently;
The water heats the synthesis gas whilst part of the water evaporates into the vapor phase until the synthesis gas is saturated;
Withdrawing via the outlet at the top from the column, a saturated synthesis gas;
Withdrawing from the outlet at the bottom the remaining water.
